(19) United States
(12) Patent Application Publication
(10) Pub. No.: US 2007/0140265 A1
(43) Pub. Date: Jun. 21, 2007

(54) Marking of a datagram transmitted over an ip network and transmission of one such datagram

(75) Inventors: Christophe Proust, Caen (FR); Noel Cantenot, Palaiseau (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 10/584,236

(22) PCT Filed: Dec. 8, 2004
(86) PCT No.: PCT/FR04/03157

§ 371 Date: Jun. 26, 2006

(30) Foreign Application Priority Data
Dec. 26, 2003 (FR) 0315470

(51) Int. Cl. H04L 12/56

(52) U.S. Cl. 370/396; 370/392

(57) ABSTRACT

The invention relates to a method of marking a datagram that is forwarded over an IP communications network by routers, which method comprises references in the fields of the datagram. When a datagram is received by a router, the router reads a reference entered in the datagram and looks up said reference in a reference table stored in the router. If the reference is not contained in the reference table, the router selects a new reference from the table. The references can correspond to routes between the router and a datagram receiver terminal. The selection of a route reference can take account of a load value assigned to said route.

The present invention relates to a method of marking datagrams forwarded in an Internet Protocol (IP) communications network and to a datagram forwarding method that may use this datagram marking method.

Identifying the path taken by a datagram in a communications network is important for several reasons, in particular for certain services that guarantee transmission quality. For example, it is preferable for successive datagrams of the same flow to take the same path in the network, to prevent them reaching a destination terminal in an order different from the order in which they were sent by a source terminal.

In the forwarding method known as “source routing”, the datagram source terminal writes a path in the network to be taken by the datagram into the datagram itself. One drawback of that method results from the fact that the terminals do not know the topology of the network, i.e. they do not know which links of the network are available and which links are not available. The path that is written in the datagram is fixed once and for all when the source terminal sends the datagram, and it is not possible to modify the path subsequently as a function of the unavailability of certain links of the network. That forwarding method is thus not able to activate mechanisms for adapting the routing function in IP networks. Furthermore, using the source routing method does not reduce the risk of congestion occurring in the network, i.e. of situations occurring in which the number of datagrams to be routed over a particular link of the network reaches or exceeds the maximum transmission capacity of that link.

Moreover, in an IPv4 network, given the size of the field of the datagram into which the path is written, the path that is written into a datagram cannot comprise more than nine routers.

Finally, the source routing method is lacking in security in the sense that the source IP address of first datagrams can be misappropriated to bypass an address-based access control system. Datagrams sent in response to the first datagrams by the source routing method may then be diverted.

In the prior art “record routing” method of identifying the path taken by a datagram in a network, each router through which a datagram passes writes its IP address into the datagram after the address written by the preceding router on the path taken by the datagram. The path taken can therefore be traced by reading the series of addresses written into the datagram. This method of identifying the path taken has the drawback that it is not possible to orient a datagram at a router as a function of data external to the router at the time of forwarding the datagram. What is more, as in the source routing method, the number of routers of the path taken by a datagram that can be written into the datagram in the record routing method is limited to nine.

An object of the invention is to mark a datagram forwarded in a communications network without encountering the drawbacks of the source routing and record routing methods referred to above.

The invention proposes a method of marking a datagram transmitted in a communications network comprising routers interconnected by transmission links. The datagram is transmitted from a datagram source terminal connected to a first router of the network to a datagram destination terminal connected to a second router of the network. The datagram comprises a vector formed of ordered fields each containing a reference and a vector index field. Each router of the network has a table of references. The method comprises the following steps executed when a router receives the datagram:
reading a value in the index field of the datagram;
reading a reference in the field of the vector of the datagram designated by the read index value;
if the table of references of the router does not contain the read reference, writing a reference selected in the table of references of the router into the field of the vector of the datagram designated by the read index value;
writing into the index field of the datagram a value equal to the read value incremented by one unit; and
forwarding the datagram to the next router of the network.

According to the method of the invention, a new reference is not written systematically into a datagram by a router. The priority is for the read reference, which constitutes data external to the router at the time of forwarding the datagram, to remain in the datagram. The router writes a new reference if the read reference is not in the router's table of references. The router then selects a new reference to be written in the datagram autonomously from its table of references.

When the destination terminal receives the datagram, each of the references written into the fields of the vector of the datagram is identical to a reference in the table of references of a router that forwarded the datagram. To be more precise, the reference written into the n^{th} field of the vector is in the table of the n^{th} router on the path in the network taken by the datagram, n being the value of the index of the vector of the datagram at the time of forwarding it in the network.

When the destination terminal receives the datagram, information is to it available as a function of the meaning of these references. If each of the references identifies a route on which the datagram was forwarded by a router, the known meanings of the references in the table of references of each router enable reconstruction of the path in the network taken by the datagram.

The marking method of the invention is secure because merely reading the references written into the vector fields of the datagram is insufficient to obtain meaningful information. It is essential also to know the meaning of each router's references. Intercepting a datagram without having that knowledge means that the references written into the datagram are of no use.

In the preferred embodiment of a marking method of the invention, the datagram belongs to a flow of datagrams sent successively by the source terminal to the destination terminal and the read reference is identical to a reference written by said router at the time of forwarding an earlier datagram of said flow. If network operation is stable, i.e. if there is no failure or congestion of certain links of the network that affects a router through which said earlier datagram has passed, the same reference in the table of references of a router through which a plurality of successive datagrams of the flow pass is then associated with all those datagrams. This results in identical marking along the path taken by the successive datagrams of the flow, with which a form of processing specific to that flow may be associated.

The invention also relates to a method of forwarding a datagram into which route references have been written. Those references may have been written into the datagram beforehand using the above marking method, but this is not obligatory, and they may have been written into the datagram by some other method, for example a source routing method. In this case, the terminals need to know the topology of the network and the tables of references of the routers.

To implement the forwarding method, a router of the network has a table of references associated with respective routes between said router and a destination terminal of the datagram connected to the network. The table of references is preferably associated with a single destination prefix contained in a routing table of the router. The forwarding method then comprises the following steps:
on reception of the datagram by the router, reading a reference in the datagram; and
looking up the read reference in the table of references of the router,
   if the table contains the read reference, forwarding the datagram along the route associated with the read reference,
   if not, selecting a reference in the table and forwarding the datagram along the route associated with the selected reference.

A forwarding method of the invention is implemented in the IP layer. A first advantage of this kind of method is that it requires only adaptation of the IP layer and does not require modification of the other protocol layers used in the routers. An existing communications network can therefore easily be adapted to use this kind of forwarding method.

A second advantage of the forwarding method of the invention is that it allows initial qualification of the path in the network taken by a datagram. Forwarding of a datagram by a router gives priority to a route reference read in the datagram. Accordingly, successive datagrams of the same flow sent by a given source terminal to a given destination terminal are forwarded on identical routes in the network if those datagrams contain the same references at the time they are sent by the source terminal and if network operation is stable.

However, if the table of references of a router does not contain the reference read in a datagram, that router selects one of the available routes for forwarding the datagram. The forwarding method of the invention therefore conforms to the main mode of operation of an IP network known as “hop by hop” operation.

The reference selected in the table of references of the router is preferably also written into the datagram using the above marking method.

If the marking and forwarding methods of the invention are simultaneously employed in an IP network, in addition to the functions of datagram forwarding and of knowing the topology of the network, the routers must modify the route references written in the datagrams. The terminals may write initial references into the datagrams without knowing the topology of the network. To this end, a terminal may store references read in a datagram it has received in order to use them as initial references for a datagram it sends.

In the preferred embodiment of a forwarding method of the invention, the table of references of the router further comprises for each reference from said table a load value assigned to the route associated with said reference. The load of a route characterizes the quantity of traffic routed along it. At the time a router forwards a datagram, if the table of references of the router does not contain the reference read in the datagram, the reference selected may correspond to a minimum load value for routes associated with references contained in said table.

This kind of forwarding method therefore takes account of the load of the various routes computed. This prevents congestion occurring on particular transmission links of the network or at least reduces the risk of congestion occurring.

This makes network operation more stable: no oscillation of load between different parts of the network is observed. A forwarding method of this kind tends to distribute and maintain the flows of datagrams in the network in a balanced manner according to the availability of resources.

The invention further relates to a terminal adapted to use a marking method as first described, a terminal of this kind comprising:
means for producing a datagram to be sent by the terminal, the datagram comprising an ordered field vector and a vector index field;
means for writing an initial reference into each field of the vector of the datagram to be sent by the terminal; and
means for writing an initial value into the index field of the datagram to be sent by the terminal.

The terminal preferably further comprises:
means for reading second references in fields of an additional vector in a datagram received by the terminal; and
means for storing the second references with communication session context data of the received datagram in a communication session context table of said terminal,
   so that the initial reference written into each field of the vector of the datagram to be sent by the terminal is one of said second references read in a field of the additional vector of the received datagram when the datagram to be sent belongs to the communication session of the received datagram. Thus references of routes determined beforehand may be used again for the datagram to be sent.

The means for producing the datagram to be sent may be adapted so that the datagram further comprises an additional field vector. The terminal then further comprises:
means for reading first references in fields of a vector contained in the received datagram;
means for storing said first references in the table of communication session contexts of said terminal with the communication session context data of the received datagram; and
means for writing said first references into the fields of the additional vector of the datagram to be sent by the terminal when the datagram to be sent belongs to the communication session of the datagram received.

Accordingly, if two such terminals each send and receive datagrams of a forward flow or a backward flow for the same communication session, initial references may be written into a forward flow datagram by the terminal sending that datagram that are identical to respective references contained in fields of said additional vector of a backward flow datagram. Applying this mechanism to the datagram source and destination terminals, the reference read by a router in the datagram is identical to a reference written by that router at the time of forwarding an earlier datagram of that flow.

The invention further relates to a router adapted to use the above forwarding method, this kind of router comprising:
means for reading a value in a vector index field of a datagram received by the router;
means for reading a reference contained in a vector field of said datagram designated by the read index value;
means for storing a table of references;
means for associating references in the table with routes;
means for looking up a read reference in the table of references of said router adapted to command forwarding of said datagram along the route associated with the read reference if the table of references contains the read reference;
means for selecting a reference in the table of references adapted to be activated if the table of references does not contain the read reference and to command forwarding of said datagram along the route associated with the selected reference; and
means for writing a value equal to the read value incremented by one unit into the index field of said datagram.

In an advantageous embodiment of the above kind of router, the association means are included in means for computing a routing table and the calculation means are included in a router control unit.

The router may be adapted to use, simultaneously, the first-defined method of marking a datagram in transit through the router. To this end, it further comprises means for writing the selected reference into the field of the vector of the datagram designated by the read index value.

Although combining in the same router the use of the marking and forwarding methods of the invention is particularly advantageous in obtaining efficient operation of the network, the router may include means for implementing the forwarding method independently of the presence in the same router of means for marking datagrams, and vice-versa. In the case of a router that uses both methods, certain of the means cited above for each method may be shared by the two methods.

The invention finally relates to a communications network that comprises the above router.

Other features and advantages of the present invention will emerge in the following description of one non-limiting embodiment of the invention, which is given with reference to the appended drawings, in which:

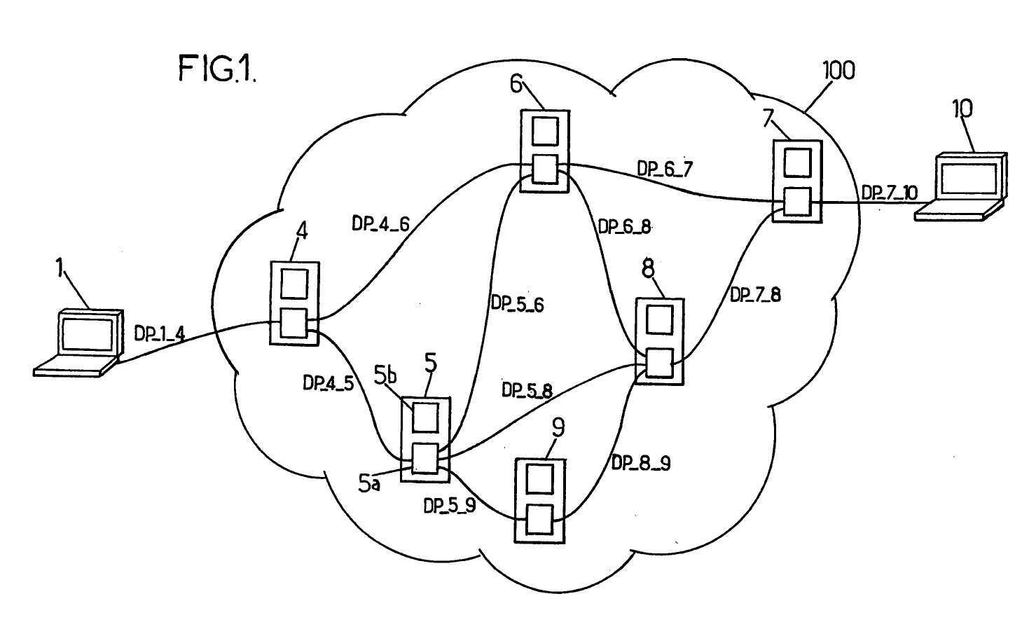

FIG. 1 represents a communications network in which the invention may be used;

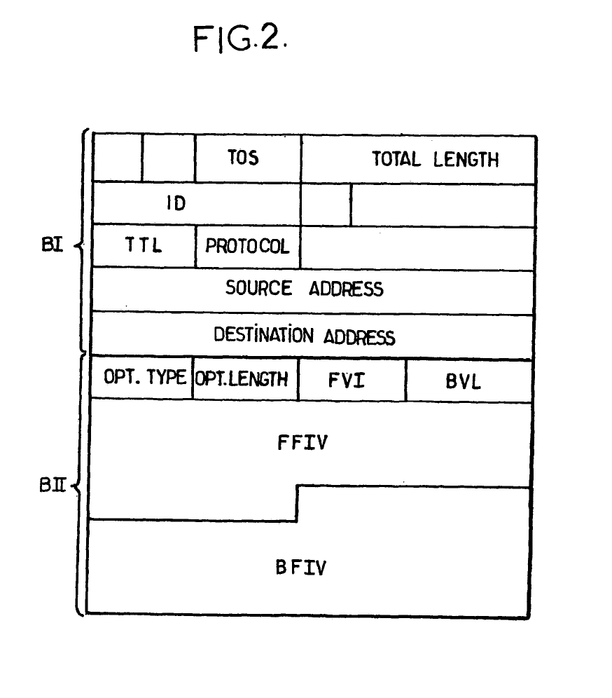

FIG. 2 shows the structure of an IP datagram header used by the invention;

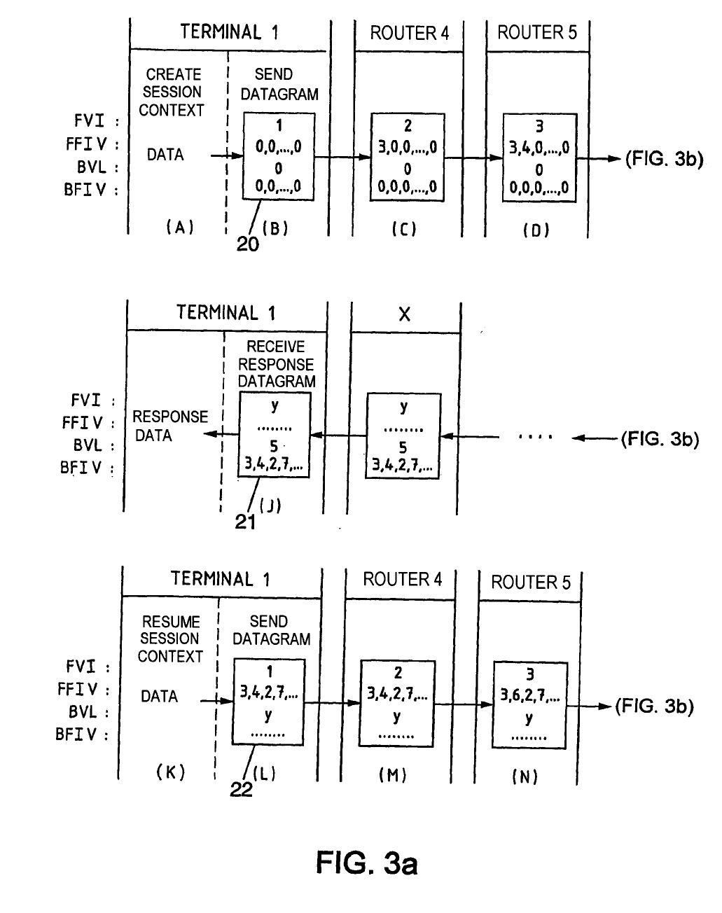

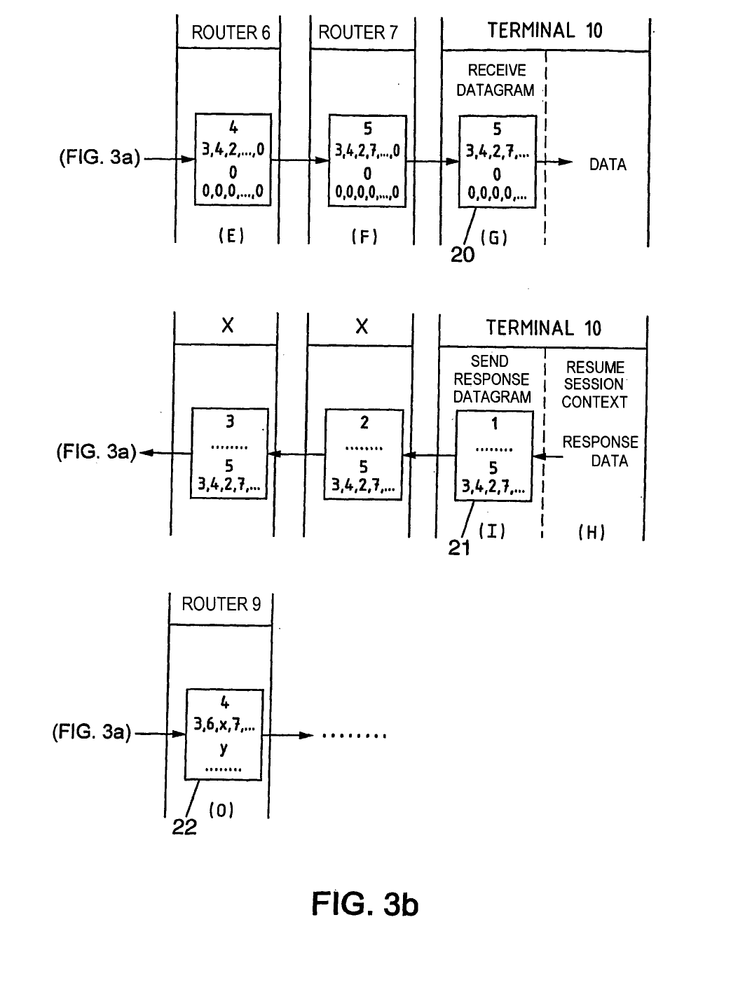

FIGS. 3a and 3b, which should be read together as one diagram, show various steps of a method of the invention of forwarding a plurality of datagrams within a network of the kind shown in FIG. 1; and

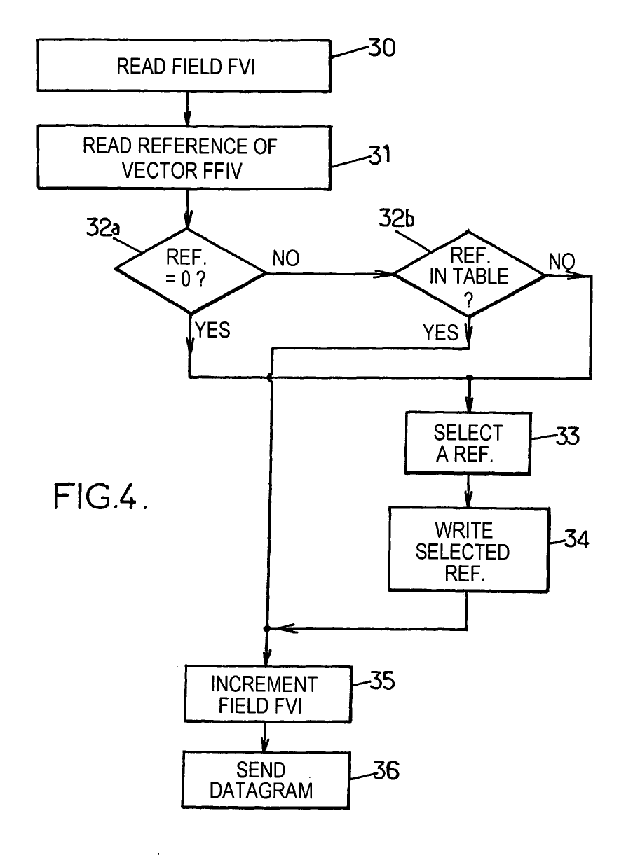

FIG. 4 is a flowchart of a method of the invention for forwarding a datagram.

Referring to FIG. 1, a communications network for sending IP datagrams 100 comprises routers 4 to 9 interconnected by transmission links. Thus a chain of routers forms a route in the network 100 for sending a datagram.

Each router may comprise a forwarding unit that transfers datagrams between two links connected to the unit and a control unit that supervises the activity of the forwarding unit. Thus the router 5 has a forwarding unit 5a and a control unit 5b.

Terminals are connected to some of the routers of the network 100. The terminals may be of different types, for example computers, mobile communications units, etc. In FIG. 1, computers 1 and 10 are connected to the routers 4 and 7, respectively. Data produced by the terminal 1 and intended for the terminal 10 is placed in IP datagrams by the terminal 1. The datagrams are forwarded via some of the routers of the network 100 to the terminal 10. It is assumed below that the reader is familiar with the operation of an IP network. In FIG. 1, each transmission link of the network 100 is identified by a prefix DP followed by identifiers of each of the routers connected to that link.

Each IP datagram has a header like that shown in FIG. 2 for Internet Protocol version 4 (IPv4). The header comprises a basic header portion BI present in all datagrams and an optional header portion BII. The header portion BI has a fixed length of 20 bytes. The length of the header portion BII may vary. The fields of the header portion BI include a SOURCE ADDRESS field which gives the IP address of the source terminal sending the datagram and a DESTINATION ADDRESS field which gives the IP address of the destination terminal for which the datagram is intended. The other fields comprise:
a TOS field (“Type of Service”), which specifies how the datagram must be managed;
a “TOTAL LENGTH” field, which specifies the total length of the datagram;
an “ID” field that receives an identification number of the datagram, in particular with a view to possible fragmentation of the datagram;
a TTL field (“Time to Live”), which gives a maximum time for which the datagram currently being forwarded in the network will exist; and
a “PROTOCOL” field, which gives the high-level protocol to which data placed by the source terminal in the data field of the datagram refers (the data field, which is also known as the “payload”, is not shown in FIG. 2).

The header portion BII comprises a first field occupying one byte labeled “OPT. TYPE”. This field receives a reference constructed in accordance with a naming system known to the person skilled in the art. To identify the nature of the content of the header portion BII, the reference specifies its presence and its class and a dedicated option number. For example, for the embodiment of the invention described below, this reference could be 10011001 in binary. The length of the header portion BII in bytes is indicated in a one-byte field “OPT. LENGTH”. This embodiment of the invention uses the maximum possible length of the header portion BII, which is 40 bytes. The 38 bytes that remain available in the header portion BII are divided into four fields, as follows:
a first one-byte field FVI (“Forward Vector Index”) that receives a numerical index value;
a second one-byte field BVL (“Backward Vector Length”) that receives a vector length value;
a first ordered series of 36 fields labeled FFIV (“Forward Flow Identifier Vector”), occupying 18 bytes in total; the fields of this first series, disposed one after the other, form a first vector and receive 36 first numerical references each coded on four bits; for clarity, the index and the first vector are respectively designated FVI and FFIV below; the FVI identifies a field in the FFIV by the ordinal number of the position of that field in the FFIV, starting from the beginning of the vector; the value of the FVI therefore varies from 1 to 36;
a second ordered series of fields labeled BFIV (“Backward Flow Identifier Vector”), also occupying 18 bytes in total; this second series of fields is organized in the same way as the first series of fields; the BFIV fields form a second vector and receive 36 second numerical references each coded on four bits; this second vector, which corresponds to the additional vector referred to in the general description of the invention, is designated BFIV below.

It is to be understood that the positions of the FVI, BVL, FFIV and BFIV fields are represented by way of example in FIG. 2. Other positions may be selected to obtain alternative embodiments of the invention. Any such alternative embodiments are within the scope of the invention. It is nevertheless particularly advantageous, in the context of Internet Protocol version 4 (IPv4), for the FVI, BVL, FFIV and BFIV fields to use the maximum length of the header portion BII.

It is also to be understood that the invention may be implemented in an equivalent manner in the context of Internet Protocol version 6 (IPv6) by adapting the FVI, BVL, FFIV and BFIV fields defined above to the specifics of this version of the Internet Protocol. In particular, Internet Protocol version 6 provides for adopting greater field and vector lengths, thanks to the possibility of defining an option header occupying more than 40 bytes.

Each router of the network 100 has a routing table known as the “Forwarding Information Database” (FIB) that is used by the forwarding unit of the router to forward received datagrams. By way of example, Table 1 below represents a portion of this kind of routing table for the FIG. 1 router 5:

TABLE 1

| Dest. Prefix | Next Hop | Interface | Encaps. L2 |
|---|---|---|---|
| DP_1_4 | DP_5_4 : 4 | ATM1/0 | xxx |
| DP_7_10 | DP_5_6 : 6 | Eth1/0 | xxx |
| DP_7_8 | DP_5_8 : 8 | ATM2/0 | xxx |
| DP_5_9 | DP_5_9 : 9 | FE1/0 | xxx |

The FIB must be read row by row, each row corresponding to a route. For example, the second row characterizes the direction to be taken to reach the destination prefix DP_{—}7_{—}10, i.e. the IP address of the next router, DP_{—}5_{—}6 : 6.

The first column “Destination Prefix” (Dest. Prefix) of the FIB groups together destination prefixes DP. For example, the destination prefix DP_{—}7_{—}10 corresponds to the subnetwork connecting the router 7 and the terminal 10. The second column “Next Hop” of the FIB indicates an IP address of a router or a terminal connected to the router 5 by a single transmission link for each destination prefix indicated in the first column. The IP addresses are constructed in a manner known in the art with a DP prefix followed by an identifier of the terminal or the router.

The “Interface” and “Encapsulation L2” (Encaps. L2) columns contain information for forwarding the datagram that is unrelated to the invention.

When a router receives a datagram, the IP address of the destination terminal of that datagram is read in the “DESTINATION ADDRESS” field of the header portion BI of the datagram. The destination prefix of the read address is isolated in a manner that is known in the art using a network mask and is identified as one of the destination prefixes contained in the first column of the FIB using the “longest match” technique.

According to the invention, the FIB of each router is completed as shown in Table 2 below, which represents by way of example a portion of the FIB for the router 5 (see FIG. 1):

TABLE 2

| Dest. Prefix | Ref. | Next Hop | Interface | Encaps. L2 | Load |
|---|---|---|---|---|---|
| DP_1_4 | 1 | DP_5_4 : 4 | xx | xxx | 50% |
| DP_1_4 | 2 | DP_5_6 : 6 | xx | xxx | 30% |
| DP_7_10 | 4 | DP_5_6 : 6 | xx | xxx | 12% |
| DP_7_10 | 1 | DP_5_8 : 8 | xx | xxx | 70% |
| DP_7_10 | 6 | DP_5_9 : 9 | xx | xxx | 20% |
| DP_6_7 | 2 | DP_5_8 : 8 | xx | xxx | 65% |
| DP_6_7 | 3 | DP_5_6 : 6 | xx | xxx | 12% |
| DP_5_9 | 2 | DP_5_9 : 9 | xx | xxx | 20% |

An FIB conforming to Table 2 has two additional columns compared to an FIB conforming to Table 1. The first of these additional columns is headed “Ref.” and contains route references. The second of these additional columns is headed “Load” and contains load values.

An FIB conforming to Table 1 indicates a single option for the router forwarding a datagram for each destination prefix. An FIB conforming to Table 2 is different in that it indicates one or more options for forwarding a datagram for each destination prefix. Each option corresponds to a different route between the router concerned, which is the router 5 in the present example, and the destination terminal whose IP address is read in the datagram. The “Ref.” column associates a numerical reference with each of those routes. The references distinguish the various routes covered by the FIB that correspond to the same destination prefix. The same reference may be used more than once in the FIB, to designate routes corresponding to different destination prefixes. The references associated with the routes covered by the FIB for the same destination prefix have only an identification function, and do not correspond to a classification. The references used depend on modifications made to the FIB during successive updates, established by the control unit of the router. The table of references referred to in the general description of the invention consists of all of the rows from the FIB that correspond to a particular single destination prefix. Accordingly, in the example corresponding to FIG. 1 and Table 2, the table of references considered for a datagram whose destination prefix is DP_{—}7_{—}10 comprises the third to fifth rows from the FIB, ignoring the row comprising the column names.

For each row from the FIB, i.e. for each route covered, the “Load” column indicates a load value determined by the control unit as a function of network status data, for example load values for at least some of the links of the network 100. The value indicated in the “Load” column for each row of the FIB may be equal to the highest of the load values of all the links along the route corresponding to that row, for example. It may be expressed in various ways, in particular as a percentage of a maximum transmission capacity for that route or as a bandwidth.

The forwarding of a plurality of datagrams within the network 100 represented in FIG. 1 is described in detail next with reference to FIGS. 3a and 3b. The letters A to O in FIGS. 3a and 3b identify the steps of the forwarding process.

When the terminal 1 produces data for the terminal 10, it places the data in successive datagrams. The method of creating datagrams is known in the art. In particular, the terminal 1 creates a communication session context (step A in FIG. 3a) that groups together the following data in particular: the respective IP addresses of the terminals 1 and 10, a transport protocol (e.g. TCP or UDP) number, and source and destination port numbers. The communication session context data is stored in the terminal 1.

When creating a first datagram 20, the terminal 1 configures the header portion BI of the datagram. In particular, it writes the respective IP addresses of the terminals 1 and 10 into the “SOURCE ADDRESS” and “DESTINATION ADDRESS” fields. It also configures the header portion BII, writing the following initial values into the various fields:
OPT. TYPE field: 10011001
OPT. LENGTH field: 40
FVI field: 1
BVL field: 0
FFIV fields: 0, 0, . . . , 0
BFIV fields: 0, 0, . . . , 0

In the method described here by way of example, the initial value of the index FVI is 1 and the initial value written into the field BVL is 0. The initial reference written into all the FFIV and BFIV fields is also 0. The reference 0 is reserved for the initialization function: it is not used to identify a route in the tables of references of the routers. As will emerge below, a terminal initializing to 0 the FFIV and BFIV fields of a datagram means that the datagram is an isolated datagram, a first datagram of a flow or a later datagram of a flow for which the sending terminal does not have predetermined initial references.

The references written in the FFIV, BFIV, FVI and BVL fields of the datagram 20 are stored by the terminal 1 with the communication session context data.

The terminal 1 then forwards the datagram to the router 4 (step B). It is assumed here that the router 4 in turn forwards the datagram 20 to the router 5 (step C). At that time, the router 4 writes the value 2 into the FVI field of the datagram 20 and the reference 3, for example, into the first FFIV field of the datagram 20.

The method of forwarding the datagram 20 used in each router is described in detail next for the router 5. During the forwarding process, the router 5 selects a row in its FIB (Table 2) in two successive steps.

In a first step of selecting a row from the FIB, the router 5 reads the IP address of the destination terminal of the datagram 20 in the “DESTINATION ADDRESS” field of the header portion BI. It isolates the destination prefix from that address and compares it to the destination prefixes in the first column of the FIB. Using the longest match technique, it selects the longest destination prefix in the FIB that corresponds to that of the IP address of the destination terminal. In this example, the destination prefix selected is DP_{—}7_{—}10 (Table 2). The “Ref.” column references in the rows of the FIB corresponding to the destination prefix DP_{—}7_{—}10 form the table of references used for forwarding the datagram 20. The table of references is therefore a portion of the FIB that corresponds to the selected single destination prefix DP_{—}7_{—}10.

The second step of selecting a row from the FIB is described next with reference to FIG. 4. The steps indicated in FIG. 4 are executed in the forwarding unit 5a.

The router 5 first reads the value written into the FVI field of the datagram 20 (step 30). Here it reads the value 2. It then reads the reference in the FFIV field whose position within that vector corresponds to the value read in the FVI field (step 31). Thus here the reference 0 is read in the second FFIV field.

As the reference read is equal to the initialization reference (step 32a), the router 5 then determines autonomously the route along which it forwards the datagram.

It selects the reference in the table of references corresponding to the destination prefix DP_{—}7_{—}10 that corresponds to a minimum load value (step 33). In the Table 2 FIB, the reference 4 corresponds to the minimum load value. The router 5 then writes the reference 4 into the FFIV field designated by the FVI (second FFIV field—step 34 in FIG. 4). It then increments the FVI value by one unit and writes the value obtained into the FVI field of the datagram 20 (step 35). The datagram 20 then contains the values and references indicated in FIG. 3a for the step D.

The row of the FIB that is selected corresponds to the selected destination prefix and to the reference 4. The router 5 forwards the datagram 20 according to the content of the “Next Hop” column for the selected row. In this example, it forwards the datagram 20 to the router 6.

The router 6 (step E in FIG. 3b) and then the router 7 (step F) each forward the datagram 20 using a method identical to that described for the router 5. The terminal 10 then receives the datagram 20 containing the FVI value and the references written into the FFIV and BFIV fields, for example those indicated in the step G. The terminal 10 stores the data of the communication session context of the datagram 20 read in the header portion BI of the datagram 20. It also stores, with the above values, the contents of the FVI, BVL, FFIV and BFIV fields. The terminal 10 then reads the data contained in the data field of the datagram 20 (this data is also known as the “payload”).

Assume now that the terminal 10 in turn produces data addressed to the terminal 1 in response to the data carried by the datagram 20. The data produced by the terminal 10 is sent in the same communication session as the datagram 20, which is part of a forward flow for this communication session, and new datagrams sent by the terminal 10 are part of a backward flow of that communication session.

Using again the data of the communication session context of the datagram 20 (FIG. 3b, step H), the terminal 10 detects a new datagram 21, which has an identical structure to the datagram 20. The terminal 10 fills in the fields of the header portion BI of the datagram 21 in the manner described above for terminal 1 and the datagram 20, interchanging the data relating to the source and destination terminals. With the stored communication session context data, the terminal 10 also recovers the references and values stored at the time of receiving the datagram 20. It writes them into the fields of the header portion BII of the datagram 21, as follows:
in successive FFIV fields of the datagram 21: the references contained in the BFIV fields of the datagram 20, in the same order;
in successive BFIV fields of the datagram 21: the references contained in the FFIV fields of the datagram 20, in the same order; and
in the BVL field of the datagram 21: the value read in the FVI field of the datagram 20.

Just like the terminal 1 at the time of sending the datagram 20, the terminal 10 writes the initial value 1 into the FVI field of the datagram 21 (step I).

The datagram 21 is sent to the terminal 1 over the network 100 in an analogous fashion to the sending of the datagram 20 described above. Note that, in principle, the datagram 21 does not pass through the same routers as the datagram 20 and that the numbers of routers through which each of the datagrams 20 and 21 respectively pass are different. In FIGS. 3a and 3b, y is the number of routers through which the datagram 21 passes. The contents of the BVL and BFIV fields of the datagram 21 are transported when the datagram 21 is sent over the network 100 but are not used. The terminal 1 receives the datagram 21 (step J in FIG. 3a) in exactly the same way as the terminal 10 receives the datagram 20, as described above. In particular, the terminal 1 stores the contents of the FVI, BVL, FFIV and BFIV fields of the datagram 21 with the communication session context data. The references written in the BFIV fields of the backward flow datagram 21 and the value written in the BVL field of the datagram 21 are then stored in both the terminals 1 and 10. Accordingly, the references written by the routers in the FFIV fields of the datagram 20 and the last value written in the FVI field of the datagram 20, i.e. the value written by the router 7, are stored in the two terminals 1 and 10 with the communication session context data.

The process described here applies to the situation in which the terminal 1 produces new data intended for the terminal 10 in response to data carried by the datagram 21. The terminal 1 then creates a datagram 22 using the procedure already described and using again the stored communication session context data (FIG. 3a, step K0). The datagram 22 belongs to the same forward flow relating to that communication session as the datagram 20.

The terminal 1 writes into the FVI field of the datagram 2 the initial value 1 and into the BVL field of the datagram 22 the FVI value y read in the datagram 21 when the terminal 1 receives it. It also writes into the FFIV fields of the datagram 22 the references read in the BFIV fields of the datagram 21 and writes into the BFIV fields of the datagram 22 the references read in the FFIV fields of the datagram 21. The values and references obtained in this way in the fields of the datagram 22 are indicated in the step L in FIG. 3a.

In other words, when a datagram belongs to a forward flow of datagrams sent successively by a source terminal to a destination terminal, said forward flow relating to a communication session, the BFIV fields of said datagram receive references written into the FFIV fields of a backward flow datagram relating to said communication session that is sent by the terminal receiving the forward flow datagrams and received by the terminal sending the forward flow datagrams before sending said forward flow datagram. Likewise, the BVL field of said forward flow datagram receives the last value written into the FVI field of said backward flow datagram.

It is assumed that the datagram 22 is sent to the router 4 by the terminal 1 and is then forwarded to the router 5 by the router 4 (step M) in the same way as the datagram 20. When the router 4 forwards the datagram 22, it increments the value of the FVI to 2. Also, the router 4 leaves the reference 3 that was written into the first FFIV field of the datagram 22.

The description of the method of forwarding a datagram by a router of the network 100 will now be concluded in the case of the datagram 22 forwarded by the router 5.

The first step of selecting a row from the FIB is identical to that described for the datagram 20.

At the time of the second step of selecting a row in the FIB, the router 5 analyses the FFIV of the datagram 22 in accordance with the FIG. 4 procedure. It reads the reference indicated by the FVI (steps 30 and 31). The reference read is 4, conforming to what the router 5 wrote into the datagram 20 during the step D of forwarding it. The read reference being different from the initialization reference 0 of the vector fields (step 32a), the router 5 looks to see if the table of references that was determined at the time of the first step of selecting a row in the FIB contains the reference 4 (step 32b). Two situations may then arise: in a first situation, the table of references still contains the reference 4; in a second situation, it no longer contains the reference 4.

The first situation arises, in particular, when the FIB of the router 5 has not been modified between forwarding the datagrams 20 and 22. It also arises if the reference 4 is still in the FIB for the destination prefix DP_{—}7_{—}10 at the time of updating the FIB between forwarding the datagrams 20 and 22. In this case, as shown in the FIG. 4 diagram, the router 5 does not modify the FFIV, the FVI is incremented (step 35), and the router 5 forwards the datagram 22 to the router 6 (step 36). The datagrams 20 and 22 are then forwarded identically by the router 5.

The second situation arises if the FIB of the router 5 is updated between forwarding the datagrams 20 and 22. Assume, for example, that in so far as the routes linking the router 5 to the terminal 10 are concerned, the update consisted only in eliminating the row in Table 2 corresponding to the destination prefix DP_{—}7_{—}10 and to the reference 4. After the first step of selecting a row from the FIB, the router 5 has selected the two rows in its FIB corresponding to the destination prefix DP_{—}7_{—}10. Those two rows constitute the relevant new table of references. The first of these two rows corresponds to the route reference 1 and the indicated load value is 70%. The second corresponds to the route reference 6 and the indicated load value is 20%. The router 5 selects that of these two references for which the route has the minimum load value (steps 32b and 33): here this is the reference 6. It then writes that reference into the second FFIV field of the datagram 22 (step 34). In the same way as before, it increments the FVI of the datagram 22 (step 35). Finally, it forwards the datagram 22 according to the content of the “Next Hop” column of the FIB for the row corresponding to the destination prefix DP_{—}7_{—}10 and to the reference 6 (step 36). In the present example, the router 5 forwards the datagram 22 to the router 9. The steps N and O in FIGS. 3a and 3b, in which x is a reference written by the router 9, show the second situation that has just been described.

When the terminal 10 receives the datagram 22, it updates the values and references stored with the communication session context data. The reference is then written into the FFIV fields of the datagram 21, copied into the BFIV fields of the datagram 22 by the terminal 1, and stored in both the terminals 1 and 10. The same applies to the last value written into the FVI field of the datagram 21.

It is clear from the above description that combining the datagram forwarding and marking methods of the invention has the following advantages:
when a new datagram belongs to a flow for which datagrams have already been sent, priority is given to using for the new datagram a route taken by an earlier datagram of the same flow;
if the route used for the earlier datagram of the flow is no longer available, the new datagram is forwarded along a new route; and
the new route is determined so as to distribute the flows of datagrams between different transmission links of the network according to their availability.

This combination combines hop by hop transmission with a reduced risk of congestion in the network and results in stable operation of the network.

Clearly the embodiment of the invention described above lends itself to variants. In particular, in FIG. 4, the steps 32a and 32b can be grouped into a single step corresponding to the same test as the step 32b.

Finally, in specific embodiments of the invention, references written into an FFIV or BFIV field of a datagram and a value written into the FVI or BVL field of a datagram may be stored in only one of the two terminals that send and receive the datagram. An embodiment of this kind may relate in particular to a backward flow datagram.

1-30. (canceled)

31. A method of marking a datagram transmitted in a communications network comprising routers interconnected by transmission links from a datagram source terminal connected to a first router of the network to a datagram destination terminal connected to a second router of the network, the datagram comprising a vector formed of ordered fields each containing a reference, the datagram further comprising a vector index field, and each router having a table of references, the method comprising the following steps executed when a router receives the datagram:
reading a value in the index field of the datagram;
reading the reference contained in the field of the vector of the datagram designated by the read index value;
if the table of the router does not contain the read reference, writing a reference selected in the table of the router into the field of the vector of the datagram designated by the read index value;
writing into the index field of the datagram a value equal to the read value incremented by one unit; and
forwarding the datagram to a next router of the network.

32. The method of claim 31, wherein the references contained in the table of references of the router are associated with respective routes in the network.

33. The method of claim 32, wherein the table of references of the router is a portion of a routing table of said router, said portion corresponding to a single destination prefix contained in the routing table.

34. The method of claim 31, wherein the datagram belongs to a flow of datagrams sent successively by the source terminal to the destination terminal, and wherein the read reference is identical to a reference written by said router at the time of forwarding an earlier datagram of said flow.

35. The method of claim 31, wherein the datagram belongs to a forward flow of datagrams sent successively by the source terminal to the destination terminal, said forward flow relating to a communication session, and wherein said datagram further comprises an additional vector formed of fields that are intended to receive references written into the fields of a vector of a backward flow datagram relating to said communication session, sent by the terminal receiving forward flow datagrams and received by the terminal sending forward flow datagrams before sending said forward flow datagram.

36. The method of claim 35, wherein initial references are written by the source terminal into the fields of the vector of said forward flow datagram, said initial references being respectively identical to references contained in fields of an additional vector of the backward flow datagram.

37. The method of claim 35, wherein said forward flow datagram further comprises a vector length field that is intended to receive the last value written into the index field of the backward flow datagram.

38. A method of forwarding a datagram by a router of a communications network, the router having a table of references associated with respective routes between said router and a destination terminal of the datagram connected to the network, the forwarding method comprising the following steps:
on reception of the datagram by the router, reading a reference in the datagram; and
looking up the read reference in the table of references of the router,
if the table contains the read reference, forwarding the datagram along the route associated with the read reference,
if not, selecting a reference in the table and forwarding the datagram along the route associated with the selected reference; in which method the read reference was written beforehand into the datagram using the marking method of claim 1.

39. The method of claim 38, wherein the reference selected in the table of references of the router is also written into said datagram using the marking method of claim 1.

40. The method of claim 38, wherein the table of references is associated with a single destination prefix contained in a routing table of said router.

41. The method of claim 40, comprising the following steps executed at the time of reception of the datagram by the router before looking up the read reference in the table of references of said router:
reading a destination address in the datagram; and
selecting in the routing table of said router the longest destination prefix corresponding to the read destination address, the table of references of said router in which the reference read in the datagram is then looked up being associated with the selected destination prefix.

42. The method of claim 38, wherein the table of references further comprises, for each reference of said table, a load value assigned to the route associated with said reference, and wherein the selected reference corresponds to a minimum load value of the routes associated with references contained in said table of references.

43. A terminal comprising:
means for producing a datagram to be sent by the terminal, the datagram comprising an ordered field vector and a vector index field;
means for writing an initial reference into each field of the vector of the datagram to be sent by the terminal; and
means for writing an initial value into the index field of the datagram to be sent by the terminal.

44. The terminal of claim 43, further comprising:
means for reading second references in fields of an additional vector contained in a datagram received by the terminal; and
means for storing the second references with communication session context data of the received datagram in a communication session context table of said terminal, wherein the initial reference written into each field of the vector of the datagram to be sent by the terminal is one of said second references read in a field of the additional vector of the received datagram when the datagram to be sent belongs to the communication session of the received datagram.

45. The terminal of claim 44, wherein the means for producing the datagram to be sent are such that the datagram to be sent further comprises an additional field vector, the terminal further comprising:
means for reading first references in fields of a vector contained in the received datagram;
means for storing said first references in the table of communication session contexts of said terminal with the communication session context data of the received datagram; and
means for writing said first references into the fields of the additional vector of the datagram to be sent by the terminal when the datagram to be sent belongs to the communication session of the datagram received.

46. A router comprising:
means for reading a value in a vector index field of a datagram received by the router;
means for reading a reference contained in a vector field of said datagram designated by the read index value;
means for storing a table of references;
means for associating references in the table with routes;
means for looking up a read reference in the table of references of said router, adapted to command forwarding of said datagram along the route associated with the read reference if the table of references contains the read reference;
means for selecting a reference in the table of references, adapted to be activated if the table of references does not contain the read reference and to command forwarding of said datagram along the route associated with the selected reference; and
means for writing a value equal to the read value incremented by one unit into the index field of said datagram.

47. The router of claim 46, further comprising means for writing the selected reference into the vector field of said datagram designated by the read index value.

48. The router of claim 46, wherein the association means are included in means for calculating a routing table of said router, said calculation means belonging to a control unit of said router;
the association means being further adapted to associate a table of references with a single destination prefix contained in the routing table of said router, the table of references of said router comprising, for each reference in said table, a load value assigned to the route associated with said reference; and
the reference selection means being adapted to select the reference for which the route corresponds to a minimum load value.
